(19) United States
(12) Patent Application Publication
(10) Pub. No.: US 2006/0023311 A1
(43) Pub. Date: Feb. 2, 2006

(54) Method for obtaining a thin, stabilized fluorine-doped silica layer, resulting thin layer, and use thereof in ophthalmic optics

(75) Inventors: Karin Scherer, Saint Maur Des Fosses (FR); Pascale Lacan, Paris (FR); Philippe Roisin, Marcoussis (FR); Richard Bosmans, Ormesson (FR)

Correspondence Address: FULBRIGHT & JAWORSKI L.L.P., 600 CONGRESS AVE., SUITE 2400, AUSTIN, TX, 78701, US

(73) Assignee: Essilor International Compangnie Generale d'Optique, Charenton cedex (FR)

(21) Appl. No.: 10/523,951

(22) PCT Filed: Aug. 7, 2003
(86) PCT No.: PCT/FR03/02487

§ 371 Date: Feb. 8, 2005

(30) Foreign Application Priority Data
Aug. 8, 2002 (FR) 0210110
Aug. 8, 2002 (FR) 0210112

(51) Int. Cl. G02B 5/08; G02B 17/00

(52) U.S. Cl. 359/603

(57) ABSTRACT

The method according to the invention comprises forming on a SiOₓF_{y} layer a silica SiO₂ and/or metal oxide protective layer obtained through ion beam-assisted vapor phase deposition, comprising bombarding the layer being formed with a beam of positive ions formed from a rare gas, oxygen or a mixture of two or more of such gases, or through cathodic sputtering of a silicon or metal layer followed by an oxidation step of the silicon or the metal layer. Application to the production of antireflection coatings.

The invention relates generally to a process for obtaining a thin stabilized, fluorine-doped silica layer (SiOₓF_{y}), such a thin layer, and the application thereof in ophthalmic optics, more particularly for obtaining multilayered antireflection coatings for ophthalmic lenses.

Silica-based (SiO₂) thin layers are widely used in optics and more particularly in the field of ophthalmic optics. Such silica-based thin layers are used in particular in antireflection coatings. Such antireflection coatings are conventionally made with a multilayered stacking of inorganic materials. These multilayered antireflection stackings usually comprise one or more layers having a low refractive index which are constituted of a silica-based thin layer.

The deposition techniques for such silica-based thin layers are very diverse, but deposition by evaporation under vacuum is one of the most commonly used techniques. These SiO₂-based thin layers possess very satisfactory mechanical properties and refractive indexes usually of the order of 1.48 for a wavelength around 630 nm.

However, in order to be able to improve the optical performance of the antireflection stacking and to generate novel systems of antireflection stackings, it would be desirable to be able to lower the refractive index of such low index layer while keeping its satisfactory mechanical properties.

In order to solve this technical problem, it has already been proposed to generate porous silica (SiO₂) layers, i.e. in which air has been captured.

Unfortunately, besides complex manufacturing techniques employed, the thus obtained layers possess unsatisfactory mechanical properties which are inferior to those of a conventional silica thin layer.

Moreover, it is known to use fluorine-doped silica thin layers in other technical fields, in particular in the field of microelectronics. In such a case, it is the decrease of the static dielectric constant that is looked for.

The layers are obtained by plasma-assisted chemical vapor phase deposition on silicon wafers.

One of the problems associated with the use of such fluorine-doped silica layers is the alteration of their properties with time.

Patent Application EP 0975017 discloses semi-conductors comprising SiO₂/SiOₓF_{y} mixed layers coated with a silicon oxynitride layer (SiON), with the aim to prevent fluorine to diffuse outside such mixed layers.

Such patent application more particularly describes that depositing a single SiO₂ layer on SiO₂/SiOₓF_{y} mixed layers does not prevent fluorine to diffuse outside said mixed layer, such a diffusion being likely to occur in the silica layer up to a depth of several hundreds of nanometers.

Obviously, the properties of the fluorine-doped silica layer are thereby altered and adhesion problems may occur at the interface of both layers.

Thus, an object of the present invention is to provide a method for obtaining a SiOₓF_{y} fluorine-doped silica thin stabilized layer, more particularly having a low refractive index, stable in time and having mechanical properties being at least comparable to prior art layers.

Another object of the invention is to provide a stabilized fluorine-doped silica layer, more particularly as defined hereinabove.

Another object of the invention is to provide a multilayered antireflection coating having at least one low refractive index layer a stabilized fluorine-doped silica layer.

Still another object of the invention is to provide an ophthalmic lens provided with an antireflection coating such as defined hereinabove.

According to the invention, obtaining a stabilized SiOₓF_{y} layer comprises coating the SiOₓF_{y} layer with a silica protective layer and/or a metal oxide through an ion beam-assisted vapor phase deposition or through a cathodic sputtering of a metal or silicon layer followed by an oxidation step of said metal or silicon layer.

By ion beam-assistance it is meant bombarding the SiO₂ silica and/or metal oxide layer, during its formation, by a beam of positive ions derived from a rare gas, from oxygen or from a mixture of two or more of such gases.

Examples of metal oxides useful within the framework of the present invention as a material for the protective coating include:

Al₂O₃ (alumina), BaTiO₃, BI₂O₃, B₂O₃, CeO₂, Cr₂O₃, Ga₂O₃, GeO₂, Fe₂O₃, HfO₂, In₂O₃, indium-tin oxide, La₂O₃, MgO, Nd₂O₃, Nb₂O₅, Pr₂O₃, Sb₂O₃, Sc₂O₃, SnO₂, Ta₂O₅, TiO, TiO₂, TiO₃, WO₃, Y₂O₃, Yb₂O₃, ZnO, ZrO₂.

The preferred protective layer within the framework of the invention is a silica and/or alumina layer, preferably a SiO₂ silica layer.

Generally speaking, it is recommended to deposit a low thickness of protective layer as well as a relatively low refractive index material, being quite close to the index of the SiOₓF_{y} layer.

Advantageously, the protective layer is 2 to 40 nm thick, preferably 5 to 30 nm and more preferably, 5 to 20 nm.

If very low thicknesses are being used for the protective layer, it is possible to use a higher index protective layer.

More precisely, if the protective layer has a thickness higher than 15 nm, the index of the protective layer material is preferably lower than 1.65.

If the protective layer is 10 to 15 nm thick, it is possible to use, as the material for the protective layer, a material with an index as high as 2.

However, and generally speaking, it is preferred to use, as a material for the protective layer, a material with an index lower than or equal to 1.65, more preferably lower than or equal to 1.6 and most preferably lower than or equal to 1.55.

In an optimal embodiment of the invention, the index of the protective layer material is lower than or equal to 1.50.

The above-mentioned indexes are refractive indexes at a 550 nm wavelength and at 25° C.

It is quite unique to notice that it is possible to obtain an excellent protection for the SiOₓF_{y} layer through very low thickness silica and/or metal oxide deposits, generally lower than 40 nm, and typically in the order of 10 nm or less.

Because of the very low thickness of the protective layer, the latter does not detrimentally alter the optical properties of the SiOₓF_{y} layer, and it is therefore possible to fully use the low refractive index of the SiOₓF_{y} layer for obtaining antireflection stackings having an improved performance over that of the prior art.

The gases to be used for the ion assistance are preferably argon, xenon, and oxygen, more preferably, argon and xenon.

The SiOₓF_{y} silicon oxyfluoride layer can be obtained through any known process.

A method is disclosed in the article <<Characteristics of SiOₓF_{y} Thin Films Prepared by Ion Beam Assisted Deposition (OSA Technical Digest, Optical Interference Coatings, 1998.6), F. J. Lee and C. K. Hwangbo describes in particular the deposition of thin films of SiOₓF_{y} in a thickness of about 600 nm on glass and silicon substrates. The basic vacuum pressure is 1.2×10⁻⁴ Pa and the temperature of the substrate is about 150° C. The silicon is evaporated by means of an electron beam in the presence of oxygen in the chamber and the silicon oxide deposit is bombarded during its formation by a beam of polyfluorocarbon ions formed by means of an ion gun starting from CF₄ gas.

A deposition method can also be used with an ion co-assistance. This method consists in evaporating silicon and/or silicon oxide and depositing the evaporated silicon and/or silicon oxide on a substrate surface for forming a layer of silicon oxide, bombarding, during its formation, the silicon oxide layer by a beam of positive ions formed from a polyfluorocarbon compound or a mixture of such compounds and also bombarding the silicon oxide layer, during its formation, by a beam of positive ions formed from a rare gas or a mixture of rare gases.

For forming the silicon oxide layer, a silicon oxide can be used having the formula SiOₓ with x<2, SiO₂ or a SiOₓ/SiO₂ mixture. Preferably, SiO₂ is used. When SiOₓ with x<2 or a SiOₓ/SiO₂ mixture is used, it is necessary that the ambient medium contains oxygen O₂.

The polyfluorocarbon compound may be a linear, branched or cyclic perfluorocarbon compound, preferably a linear or cyclic one.

Linear perfluorocarbon compounds may include CF₄, C₂F₆, C₃F₈ et C₄F₁₀; the cyclic perfluorocarbon compounds may include C₃F₆ and C₄F₈; the preferred linear perfluorocarbon compound is CF₄ and the preferred cyclic compound is C₄F₈.

A mixture of perfluorocarbon compounds may also be used.

The polyfluorocarbon compound may also be a hydrogeno fluorocarbon preferably selected amongst CHF₃, CH₂F₂, C₂F₄H₂. The hydrogen fluorocarbon may also be linear, branched or cyclic.

Naturally, a mixture of perfluorocarbon and hydrogenofluorocarbon compounds may be used.

The rare gas is preferably selected from xenon, krypton and mixtures thereof. The preferred rare gas is xenon. If needed, oxygen can be used for providing the co-assistance.

During the deposition of the fluorine-doped silica layer, the substrate is generally at a temperature lower than 150° C., preferably lower than or equal to 120° C. and more preferably varies from 30° C. to 100° C.

Preferably, the temperature of the substrate varies from 50 to 90° C.

Depositing the SiOₓF_{y} layer is carried out in a vacuum chamber at a pressure of 10-2 to 10-3 Pa. If necessary, oxygen gas can be introduced into the vacuum chamber during the deposition of the layer.

Depositing the silicon oxyfluoride layer can be performed by means of cathodic sputtering of a silicon layer followed by an oxidation step of the silicon layer in the presence of a fluorinated gas, for example, by means of an oxygen plasma in the presence of a fluorinated gas such as CF₄.

The method of deposition in a vapor phase is preferred over the cathodic sputtering.

The fluorine-doped silicon oxide layers usually have a thickness of 5 to 300 nm, preferably from 30 to 160 nm, more preferably from 30 to 100 nm.

The resulting fluorine-doped silicon oxide layers have a refractive index n generally ranging from 1.38 to 1.44 (for a radiation of a wavelength λ=632.8 nm at 25° C.).

Preferably, the deposition of the SiOₓF_{y} layer occurs without any ion co-assistance.

The layers deposited under ion assistance with rare gases or oxygen generally have therein high stresses, which may be detrimental to their mechanical properties, and when these are part of a stacking, to the overall properties thereof.

However, in the present case, the very low thicknesses of the protective layer minimize such an effect and it has been observed that the antireflection stackings comprising the SiOₓF_{y} layer stabilized by the protective layer had quite acceptable mechanical properties which are comparable to the conventional antireflection ones.

The invention therefore also relates to multi-layered antireflection coatings comprising at least one stabilized SiOₓF_{y} thin layer according to the invention.

The conventional antireflection coatings are made with a mono-layered stacking with a low refractive index (LI) or a multilayered stacking; for example, a high index (HI)/low index (LI) bilayer, (LI/HI/LI) trilayer, (HI/LI/HI/LI) tetralayer, the indexes and thicknesses of which being appropriately selected so as to obtain the antireflection effect, as is known to the person skilled in the art.

Usually, the low index layers are based on SiO₂ silica.

The material with a high refractive index (HI) to be used is a material with a refractive index higher than or equal to 1.55, preferably, higher than or equal to 1.60 and more preferably, higher than or equal to 1.65.

The material with a low refractive index (LI) to be used preferably has a refractive index lower than or equal to 1.52, preferably, lower than or equal to 1.50.

Generally speaking, the refractive indexes being referred to are indexes at a 550 nm wavelength and at 25° C., unless otherwise specified.

The various layers of the antireflection stacking can also be manufactured through cathodic sputtering of a metal or silicon followed by an oxidation step of the metal or the silicon. Using the cathodic sputtering allows with one single device to manufacture all the layers of the stacking and also the SiOₓF_{y} layer and the SiO₂ or metal oxide protective layer by simply changing the sputtered metal and introducing a fluorine precursor gas in the oxygen during the oxidation step when this is required.

The processes and devices for making the metal oxide and silicon dioxide layers by cathodic sputtering are well known. The Metamode® commercially available process from the OCLI Corporation and the Applied Vision RFX10 sputtering device are to be mentioned.

According to the invention, as the low index layer, a stabilized SiOₓF_{y}/SiO₂ and/or metal oxide layer is used.

In the case of a multilayered coating comprising two or more low index layers, at least one of the low index layers is made by the SiOₓF_{y}/SiO₂ and/or metal oxide bilayer according to the invention. Preferably the SiOₓF_{y}/SiO₂ and/or metal oxide bilayer according to the invention is used for the low index layers in the higher position in the stacking, i.e. the ones being nearest to the air, as this is the case where the antireflection improvements are the most substantial.

In the case of an antireflection coating comprising four HI/LI/HI/LI layers from the substrate surface, the thicknesses of such layers vary preferably in the following respective order, from the substrate surface:
HI: from 0.10 to 40 nm
LI: from 10 to 55 nm, preferably, from 10 to 45 nm
HI: from 30 to 155 nm, preferably from 40 to 150 nm, and more preferably from 120 to 150 nm
LI (SiOₓF_{y} layer): from 70 to 110 nm
Protective layer: from 2 to 50 nm.

The antireflection coatings according to the invention can also comprise six layers, in the following respective order, from the substrate surface: HI/LI/HI/LI/HI/LI.

In such a case, the thicknesses of said layers preferably vary in the following respective order, from the substrate surface:
HI: from 10 to 30 nm
BI: from 10 to 55 nm, preferably, from 10 to 45 nm
HI: from 10 to 160 nm
BI: from 10 to 45 nm
HI: from 35 to 170 nm
BI: from 70 to 95 nm
Protective layer: from 2 to 40 nm.

The antireflection coatings according to the invention make it possible to obtain lower reflection coefficients Rm (average of the reflection between 400 and 700 nm) than prior art coatings, with a comparable stacking.

The antireflection coatings according to the invention generally possess a Rm lower than 0.6%, preferably lower than 0.5%, and more preferably lower than or equal to 0.4% (by side of the coated substrate of said antireflection coating).

It is possible to obtain antireflection coatings with a Rm lower than 0.3%.

The definitions of the reflection coefficients (p) at a given wavelength and Rm (average of the reflection between 400 and 700 nm) are known to the person skilled in the art and are mentioned in the standard ISO/WD 8980-4 (specification and method of tests for antireflection coatings).

The SiOₓF_{y}/SiO₂ and/or metal oxide bilayer according to the invention, as well as the antireflection coatings including such a bilayer, may be deposited on any appropriate substrate, such as silicon, mineral glass or organic glass substrates, for example, organic glass lenses, such substrates being optionally coated with anti-abrasion or anti-shock films, or others as conventionally used.

Naturally, the antireflection coatings according to the invention may comprise coatings adapted to modify their surface properties, such as anti-fouling hydrophobic coatings. These are generally fluorosilane-type materials of a few nanometer thickness.

The remainder of the description refers to the appended figures which respectively represent:

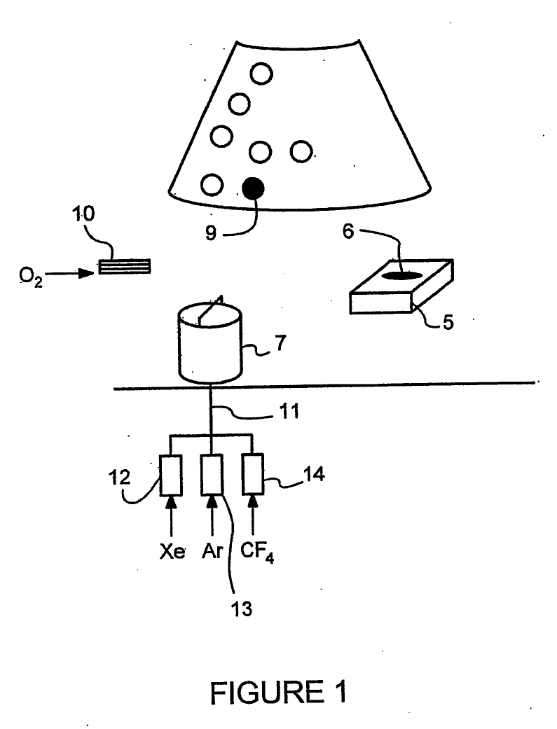

FIG. 1, a schematic view of a device for carrying out the process of the invention;

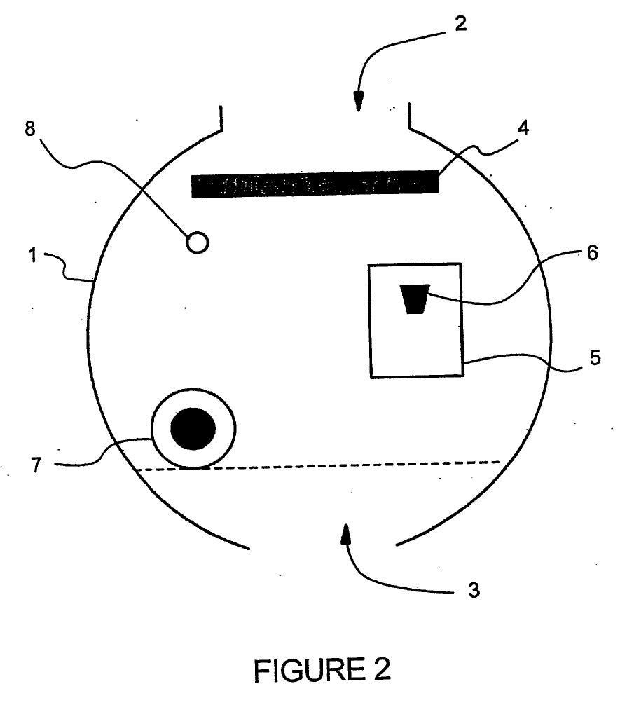

FIG. 2, a schematic top view of the device of FIG. 1;

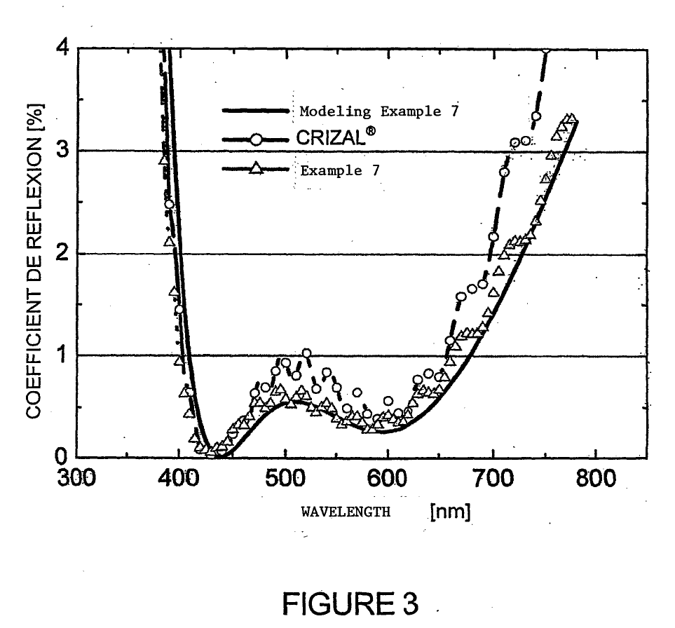

FIG. 3, a diagram of the reflection coefficient as a function of the wavelength after depositing the antireflection coatings according to the invention and those commercially available;

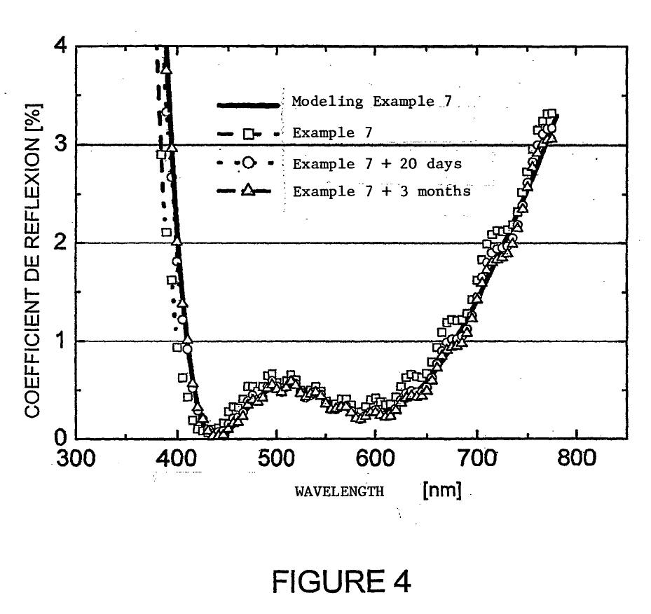

FIG. 4, a diagram of the reflection coefficient as a function of the wavelength of an antireflection coating according to the invention and its evolution in time;

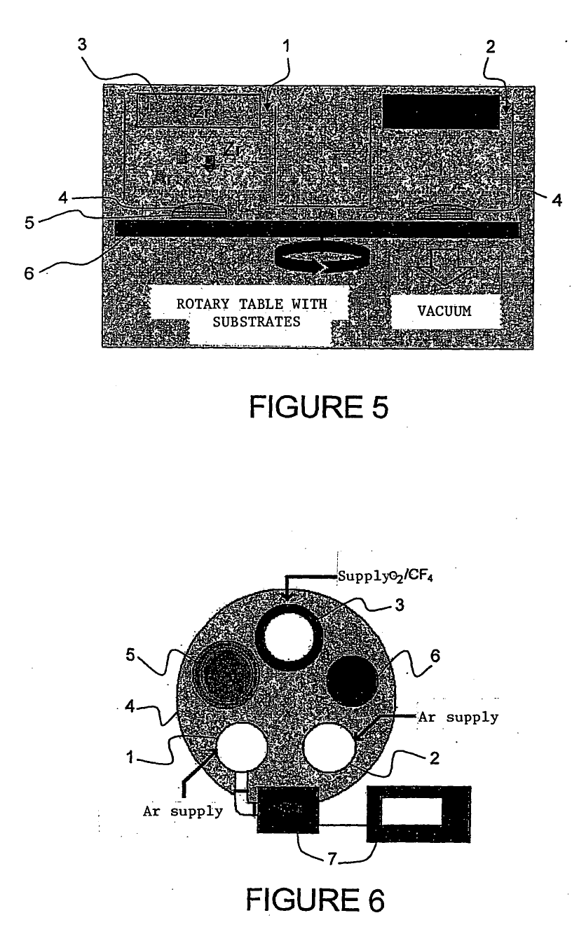

FIG. 5, a flow diagram of the Metamode® process applied to depositing a metal oxide layer; and

FIG. 6, a top view of the Applied Vision sputtering device for implementing the Metamode® process.

The device for depositing thin films assisted by an ion beam shown in the FIGS. 1 and 2 is a standard device. This device comprises a vacuum chamber 1, the first end 2 of which is connected with one or more vacuum pumps and the other opposite end comprises a door 3. A cold trap 4 may be placed in the chamber close to the end 2 connected with the vacuum pumps. Within the chamber 1 an electron gun 5 is located comprising a crucible 6 adapted to contain the silica to be vaporized. The substrates to be coated A are arranged on a support close to a quartz micro-balance 9. If needed, provision may also be made for an oxygen gas supply to chamber 10. The pressure in the chamber can be measured by means of a hot cathode pressure gauge 8. The supply line 11 of the ion gun 7 is connected with three gas feed drive devices making it possible to simultaneously or independently supply the ion gun with gases of the desired nature and/or flow rates.

In the present case, the vacuum chamber is a Leybold Heraeus chamber adapted to reach a basic vacuum of 5.10⁻⁵ Pa, the ion gun is a MARK II Commonwealth gun, and the electron gun is a Leybold ESV gun.

For the gas feed drive devices for the ion gun, a BROOKS mass flow control device is used for argon gas, itself controlled by the MARK II control device. For feeding xenon and polyfluorocarbon compound, mass flow control devices are used such as the multigas control device MKS 647 B in which the nature and flow rate of the gases can be programmed.

The same device can also be used for a SiOₓF_{y} deposition without any ion co-assistance.

The deposition on the substrates of the stabilized fluorine-doped silica layer according to the invention can be carried out in the following manner:

The chamber 1 is placed under a vacuum of 2.10⁻³ Pa (measured by means of the hot cathode gauge 8). The ion gun 7 is initiated with argon gas, then CF₄ gas is introduced (and optionally, a rare gas such as Xe) at the selected flow rate and the argon flow is interrupted (or set at the selected flow rate). The silica (SiO₂) particles located in the crucible 6 are preheated by the electron beam gun. When oxygen gas is used in the chamber 1, it is introduced therein at a controlled flow rate. The electron beam gun 5 and the ion gun 7 are both equipped with a plug, and both plugs of the electron beam gun and the ion gun are opened simultaneously. The thickness of the deposit is regulated by the quartz micro-balance 9 near to the sample substrates When the desired thickness of the SiOₓF_{y} layer is obtained, both plugs are closed, the emission of the electron beam gun 5 is reduced, Ar or Xe (or O₂) gas is introduced at the selected flow rate in the ion gun 7, then the CF₄ flow is stopped. When the anode voltage and the anode current of the ion gun 7 are stabilized, both plugs are opened, and therefore, a SiO₂ layer is deposited with an ion beam assistance (SiO₂ IAD). When the selected thickness of the SiO₂ IAD layer is obtained, both plugs are closed, the electron beam 5 and ion 7 guns 5 are cut off, the supply of the various gases is stopped, and the vacuum in the chamber 1 is broken.

If an Ar/CF₄ or Xe/CF₄ or O₂/CF₄ mixture is used for depositing the SiOₓF_{y} layer, when the selected thickness of the SiOₓF_{y} layer is reached, the CF₄ flow is stopped and the Ar or Xe or O₂ selected flow rate is regulated. In such a way, a SiO₂ IAD layer is deposited. When the selected thickness of the SiO₂ IAD layer is reached, both plugs are closed, the electron beam and ion guns are cut off, the supply of the various gases is stopped, and the vacuum in the chamber 1 is broken.

Naturally, for depositing the SiOₓF_{y} layer, one may not use an ion co-assistance. In such a case, no rare gas should be introduced into the ion gun 7.

The following examples illustrate the present invention.

By proceeding as previously described, flat surface silicon samples have been coated with fluorine-doped silica layers.

The depositing rate was constant at 0.8 nm/sec.

### COMPARATIVE EXAMPLE A

In this comparative example, no protective layer has been deposited. The deposition conditions and the thickness of the SiOₓF_{y} layer are indicated in the following table.

Deposition Condition for the SiOₓF_{y} Layer

| | | | | Anode |
|---|---|---|---|---|
| | Thickness | CF₄ flow rate | Anode current | Voltage |
| Reference | SiOₓF_{y} [nm] | [cm³/minute] | [A] | [V] |
| Comparative | 230 | 3 | 0.7 | 100 |
| Example A | | | | |

### EXAMPLES 1 TO 6

CF₄

(CF₄, Ar, Xe in Mark II, O₂ in the enclosure)

| Deposition Conditions for the SiOₓF_{y} layer | | | | | | | Deposition Conditions for the protective layer | | | |
|---|---|---|---|---|---|---|---|---|---|---|
| | Thickness | Flow rate | Gas flow | O₂ Flow | Anode | | Barrier layer | | | |
| | SiOₓF_{y} | CF₄ | rate | rate [cm³/ | current | Anode | thickness | Gas flow rate | Anode | Anode |
| N° | [nm] | [cm³/min] | [cm³/min] | min] | [A] | voltage [V] | [nm] | [cm³/min] | current [A] | voltage [V] |
| 1 | 185 | 2.5 | | 4 | 0.4 | 100 | 95 | 1.8* | 0.6 | 100 |
| 2 | 185 | 2.5 | | | 0.4 | 100 | 45 | 1.5* | 0.6 | 100 |
| 3 | 195 | 2.5 | 1.7* | 4 | 1.9 | 100 | 10 | 1.7* | 0.6 | 100 |
| 4 | 190 | 3 | | | 0.7 | 120 | 45 | 1.8* | 0.6 | 100 |
| 5 | 190 | 2 | 7⁺ | | 2.8 | 100 | 45 | 6⁺ | 1 | 100 |

C₂F₆
(C₂F₆ and Xe in Mark II)

| | | | | | Barrier | | | |
|---|---|---|---|---|---|---|---|---|
| | Thickness | C₂F₆ Flow | Anode | Anode | layer | | Anode | Anode |
| | SiOₓF_{y} | rate | current | Voltage | thickness | Xe Flow rate | current | Voltage |
| N° | [nm] | [cm³/minute] | [A] | [V] | [nm] | [cm³/minute] | [A] | [V] |
| 6 | 210 | 3 | 0.7 | 100 | 45 | 0.6 | 0.6 | 100 |

*Xe, ⁺Ar

The refractive index has been determined at 25° C. for the SiOₓF_{y} layers obtained for λ=632 nm from ellipsometry spectra.

The presence or the absence of water in the SiOₓF_{y} layer has also been determined through the presence or not of a peak between 3400 and 3600 cm⁻¹ in the infrared spectra of such a layer.

The results are presented in the following table:

| | | Comparative | | | | | | | |
|---|---|---|---|---|---|---|---|---|---|
| | | Example A | | | | 2 | | 3 | |
| | | n | | 1 | | n | | n | |
| | | (SiOₓF_{y}) | | n | | (SiOₓF_{y}) | | (SiOₓF_{y}) | |
| Time after | | @ 632 | Presence | (SiOₓF_{y}) | Presence | @ 632 | Presence | @ 632 | Presence |
| deposition | | nm | of water | @ 632 nm | of water | nm | of water | nm | of water |
| 10 | min | 1.396 | no | | | | | | |
| 1 | hour | 1.400 | | | no | | no | | no |
| 2 | hours | 1.403 | | 1.411 | no | 1.417 | no | 1.421 | no |
| 3 | days | 1.440 | yes | 1.412 | no | 1.415 | no | 1.422 | no |
| 1 | mo. | 1.458 | yes | | | 1.418 | no | 1.421 | no |
| 3.5 | mo. | | | | | | | | |
| 6 | mo. | | | 1.404 | | 1.416 | no | 1.424 | no |
| 8 | mo. | | | | | | | | |

| | | 4 | | 5 | | 6 | |
|---|---|---|---|---|---|---|---|
| | | n | | n | | n | |
| Time after | | (SiOₓF_{y}) | Presence | (SiOₓF_{y}) | Presence | (SiOₓF_{y}) | Presence |
| deposition | | @ 632 nm | of water | @ 632 nm | of water | @ 632 nm | of water |
| 10 | min | | | | | | |
| 1 | hour | | no | | no | 1.434 | no |
| 2 | hours | 1.385 | no | 1.404 | no | | |
| 3 | days | 1.384 | no | 1.400 | no | | |
| 1 | mo. | 1.383 | no | 1.394 | no | | |
| 3.5 | mo. | | | | | 1.432 | no |
| 6 | mo. | | | 1.400 | no | | |
| 8 | mo. | 1.388 | no | | | | |

For the unprotected SiOₓF_{y} layer, the index increases from 1.40 to 1.46 (SiO₂ index) over 1 month, while for the protected layers according to the invention, the index does not change for at least several months.

### EXEMPLE 7

The example 7 is an example of an antireflection coating, which can be carried out using the SiOₓF_{y}/SiO₂ layers of the invention.

The substrate on which such an antireflection coating is produced is an Orma® substrate (diethylene glycol diallylcarbonate based material) coated with an antiabrasion varnish of the epoxysilane hydrolysate type. The antiabrasion varnish to be used has been obtained through pouring dropwise 80.5 parts of HCl 0.1N in a solution containing 224 parts of γ-glycidoxypropyltrimethoxysilane and 120 parts of dimethyldiethoxysilane. The hydrolyzed solution is stirred 24 hours at room temperature, then 718 parts of a 30% colloidal silica in the methanol, 15 parts of aluminium acetylacetonate and 44 parts of ethylcellosolve are added.

A small amount of surfactant is added.

The substrate coated with the varnish is subjected to a 15 minute prebaking step at 60° C., and is then placed in a steaming room at 100° C. for 3 hours.

The coating in example 7 is made up of a stacking of layers, starting from the higher layer to the lower layer in contact with the substrate, comprising:
a SiO₂ IAD layer, being 10 nm thick;
a SiOₓF_{y} layer, being 92 nm thick (n=1.42);
a ZrO2 layer, being 42 nm thick;
a SiO₂ layer, being 41 nm thick;
a ZrO2 layer, being 25 nm thick;
Such a coating has a Rm of 0.5 and a Rv (such as defined in the above mentioned ISO WD 8930-4) of 0.4.

The SiOₓF_{y} and SiO₂ IAD layers (barrier layer) were produced as previously described with the following operating conditions.

| | | | | | | | Deposition Conditions for the | | | |
|---|---|---|---|---|---|---|---|---|---|---|
| Deposition Conditions for the SiOₓF_{y} layer | | | | | | | protective layer | | | |
| | | | | | | | Barrier | | | |
| | Thickness | CF₄ Flow | Air Flow | O₂ Flow | Anode | Anode | layer | Ar Flow | Anode | Anode |
| | SiOₓF_{y} | rate | rate | rate | current | voltage | thickess | rate | current | voltage |
| Example | [nm] | [cm³/min] | [cm³/min] | [cm³/min] | [A] | [V] | [nm] | [cm³/min] | [A] | [V] |
| 7 | 92 | 2.0 | 6 | | 2.2 | 100 | 10 | 6 | 1 | 100 |

The other layers of the stacking are deposited in vapor phase under the conventional conditions as known to the person skilled in the art.

On the antireflection stacking of example 7, a test of <<n×10 strokes>> has been conducted. The number of cycles that the stacking can withstand is at least 12.

FIG. 4 is a diagram of the reflection coefficient of the substrate surface as a function of the wavelength, after deposition of the coating of example 7 and of a commercial CRIZAL® antireflection coating formed on an identical substrate.

FIG. 5 is a diagram of the reflection coefficient as a function of the wavelength of the coating of example 7, after deposition, 20 days after the deposition and 3 months after the deposition.

On those figures, the full line curve represents the reflection coefficient as a function of the wavelength of a coating similar to that of example 7, but obtained through modelling according to conventional techniques known to the person skilled in the art.

It can be seen that the antireflection coating according to the invention has an excellent stability in time, comparable to that of conventional coatings.

Descriptions of the Measurement Methods and Tests n×10 Stroke Test

The n×10 stroke test is described in Patent Application WO/9949097.

Briefly, a fabric is applied to the antireflection treated lens surface and a gum is pressed onto the fabric. The gum and the substrate are then moved one from the other following a back and forth movement. A cycle represents 10 back and forth movements.

The result represents the number of cycles that an antireflection treated lens can withstand before any defect appears.

Refractive Index Measurement Method

Generally, the refractive index is measured through ellipsometry on silicon flat discs.

For the layer in the comparative example A, a SENTECH SE 400 ellipsometer has been used, being calibrated by the SENTECH Corporation.

The measurements are carried out at a wavelength of 632.8 nm at an angle of 70°. The refractive index and the thickness are calculated from tan Ψ and cos Δ by a two-dimensional Newton method, using the following model:

SiOF (n,t)
native SiO₂ (2 nm, n = 1.457)
Si (n = 3,881, k = 0.020)

For the SiOₓF_{y} layers+protective (barrier) layer, a SOPRA GESP 5 VASE variable angle ellipsometer is used. The device is calibrated according to the procedure as recommended by SOPRA. The tan Ψ and cos Δ spectra between 300 and 850 nm are measured for 3 incident angles 65°, 70° and 75°. With the regression method according to Levenberg-Marquardt, a global adaptation is carried out on 3 spectra using the following model:

SiO₂ (t₁, a₁)
SiOF (t₂, A₂)
native SiO₂
Si

The dispersion curve for Si and for SiO₂ (native) originates from files supplied by SOPRA. For the SiOF and SiO₂ barrier, it is assumed that the dispersion curve obeys a Cauchy law (n=A+Bλ²=C/λ⁴, λ en μm), with B=0.003 and C=0.

Characteristic of the Flat Discs

If {100}, 500 μm thickness, p doped (B), resistivity >100 Ωcm, two sides polished; (for the IR measurements) 6 samples are cut in a 50 mm Ø wafer; -->qqs (˜3) cm² per sample.

The following examples describe feasible antireflection coatings comprising a SiOₓF_{y} layer stabilized by the protective layer (in a barrier layer) according to the invention as well as their optical performances.

The optical performance (reflection coefficients) is determined by the FILM STAR DESIGN commercial software from FTG Software Associates—Princetown N.J. and is indicated hereinafter.

The optical performance of such stackings can also be determined without using the above-mentioned software, through a simple calculation, following the basic principles of the thin layer optics, known to the person skilled in the art and more particularly set forth in the works <<Thin film optical filters>> Adam Higer Ltd—Bristol 1969 H. A. Mc Loed—Professor of Optical Sciences—University of Arizona—Tuckson.

In the following examples and tables, the layer thicknesses are, unless otherwise specified, indicated in nanometers (nm).

Similarly, unless otherwise specified, the refractive indexes are indexes at 550 nm, 25° C.

The materials being used in the examples are as follows:

| Designation of the | | |
|---|---|---|
| material | Nature of the material | Refractive index |
| O | SiOxFy | 1.423 |
| N | SiOxFy | 1.388 |
| Q | SiO₂ | 1.473 |
| Z | ZrO₂ | 1.997 |
| A | Al₂O₃ | 1.646 |

### EXAMPLES 8 TO 10

The examples 8 to 10 illustrate three antireflection stackings according to the invention, deposited on an ORMA® glass, based on CR39®.

Successively are used as the protective layer, a silica layer, an alumina layer, a zirconia layer, each being 10 nm thick.

The stackings are described starting from the lower layer, in contact with the substrate, up to the higher layer (LI—protective layer).

| Layer | Example 8 | | Example 9 | | Example 10 | |
|---|---|---|---|---|---|---|
| nature | Material | Thickness | Material | Thickness | Material | Thickness |
| HI | Z | 13 | Z | 13 | Z | 33 |
| LI | Q | 38 | Q | 38 | Q | 21 |
| HI | Z | 135 | Z | 135 | Z | 67 |
| LI | N | 82 | N | 76 | N | 68 |
| Pro- | Q | 10 | A | 10 | Z | 10 |
| tective | | | | | | |
| layer | | | | | | |

| | | | |
|---|---|---|---|
| Rm (%) | 0.21 | 0.26 | 0.53 |
| stacking | | | |

The above-mentioned table illustrates the fact that it is desirable to use a relatively low index protective layer, more particularly based on SiO₂ in order to obtain the lowest Rm values.

It can however be seen that it is possible to obtain low Rm values (lower than 0.6%), even using a high index barrier layer, as long as the thickness of such a layer is low (10 nm).

### EXAMPLES 11 TO 17

Such examples describe antireflection coatings or stackings containing four layers and a protective layer, which is the last layer of the deposition.

| Layer | | Thicknesses (layers) [nm] | | | | | | |
|---|---|---|---|---|---|---|---|---|
| nature | Material | Ex. 11 | Ex. 12 | Ex. 13 | Ex. 14 | Ex. 15 | Ex. 16 | Ex. 17 |
| HI | Z | 40 | 10 | 13 | 14 | 19 | 25 | 26 |
| LI | Q | 16 | 31 | 45 | 25 | 38 | 39 | 10 |
| HI | Z | 64 | 126 | 137 | 117 | 150 | 40 | 94 |
| LI | O | 84 | 76 | 82 | 70 | 84 | 94 | 78 |
| Protective | Q | 10 | 10 | 10 | 10 | 10 | 10 | 10 |
| layer | | | | | | | | |
| Rm (%) | | 0.5 | 0.4 | 0.42 | 0.49 | 0.47 | 0.47 | 0.45 |

### EXAMPLES 18 TO 24

The examples 18 to 24 illustrate the antireflection stackings of the same type as those described in examples 11 to 17, but using as a low index i.e. layer, the last layer being deposited, a lower index SiOₓF_{y} layer (N layer).

| Layer | | Thicknesses (layers) (nm) | | | | | | |
|---|---|---|---|---|---|---|---|---|
| nature | Material | Ex. 18 | Ex. 19 | Ex. 20 | Ex. 21 | Ex. 22 | Ex. 23 | Ex. 24 |
| HI | Z | 40 | 10 | 10 | 20 | 12 | 19 | 26 |
| LI | Q | 18 | 20 | 55 | 37 | 29 | 50 | 10 |
| HI | Z | 59 | 127 | 136 | 155 | 123 | 30 | 95 |
| LI | N | 86 | 82 | 83 | 85 | 70 | 100 | 78 |
| Protective | Q | 10 | 10 | 10 | 10 | 10 | 10 | 10 |
| layer | | | | | | | | |
| Rm (%) | | 0.43 | 0.38 | 0.46 | 0.47 | 0.44 | 0.44 | 0.40 |

### EXAMPLES 25 TO 28

In the examples 25 to 28, the thickness of the barrier layer is made to vary.

| | | Thicknesses (layers) (nm) | | | |
|---|---|---|---|---|---|
| Layer nature | Material | Ex. 25 | Ex. 26 | Ex. 27 | Ex. 28 |
| HI | Z | 13 | 13 | 13 | 13 |
| LI | Q | 38 | 38 | 38 | 37 |
| HI | Z | 134 | 135 | 135 | 135 |
| LI | N | 92 | 82 | 63 | 41 |
| Protective | Q | 2 | 10 | 25 | 45 |
| layer | | | | | |
| Rm (%) | | 0.2 | 0.21 | 0.27 | 0.44 |

### EXAMPLES 29 TO 31

The examples 29 to 31 describe antireflection stackings comprising 6 layers and a protective layer, the last layer of the deposition.

| | | Thicknesses (layers) (nm) | | |
|---|---|---|---|---|
| Layer nature | Material | Ex. 29 | Ex. 30 | Ex. 31 |
| HI | Z | 16 | 10 | 10 |
| LI | Q | 33 | 66 | 10 |
| HI | Z | 157 | 23 | 10 |
| LI | Q | 17 | 41 | 11 |
| HI | Z | 150 | 139 | 109 |
| LI | O | 81 | 79 | 78 |
| Protective layer | Q | 10 | 10 | 10 |
| Rm (%) | | 0.29 | 0.40 | 0.39 |

As previously indicated, another method for depositing the metal oxide or silicon oxide protective layer as well as the SiOₓF_{y} layer, is a cathodic spraying deposition or <<sputtering>> followed by an oxidation step or an oxidation in the presence of a fluorinated gas.

Preferably, depositing the metal oxide or silicon layer occurs carrying out successively the following steps of:
1) depositing a thin metal or silicon layer through cathodic sputtering,
2) oxidizing the resulting thin layer by oxygen, preferably under the form of a reactive plasma,
and repeating such operations as many times as required for obtaining the desired thickness of the protective layer.

Preferably, the deposition 1) and oxidation 2) steps are carried out in two locally distinct processing areas.

The sputtering technique for the thin metal or silicon layer [step 1)] is generally a direct current discharge (dc sputtering) and is carried out under vacuum.

According to this technique, the target, or cathode, made in the material (metal or silicon) to be deposited is supplied by a direct current generator of several kV. The substrate to be coated is placed on an anode, opposite to the target being cooled down through water recycling. After establishing the vacuum, a gas is introduced therein (most often, Argon), and a negative voltage is applied onto the target in order to initiate the plasma. The positive ions present in the plasma, accelerated towards the target, project the target atoms. The ion impact also causes the ejection of some electron, the so-called secondary electrons, which are accelerated and collide with the gas atoms, allowing to maintain the plasma. The target atoms, once ejected, are deposited on the substrate and thereby create a thin layer.

Other more sophisticated cathodic sputtering techniques are preferred for implementing the invention.

Thus, preferably, a separately supplied anode is used which is not in contact with the substrate.

Preferably still, a magnetron cathode is used. Such cathodes are diode-type cathodes wherein a magnetic field is an electron trap. The electronic currents move in a direction being perpendicular both to the electric field and to the magnetic field according to paths being cycloidal. Thus, they acquire a higher energy, and, more important, travel on much longer distances than in the continuous diode technique. The ionizing collisions are therefore more numerous, hence the densities of the ion current on the target are also higher.

Magnetrons are more particularly described in the works <<Handbook of deposition technologies for films and coatings>> Science, Technology and Applications, Rointan F. Bunshah 2^{nd} Edition 1994 pp 280-292.

As far as step 2) is concerned, as previously indicated, an oxygen plasma or an oxygen-fluorinated gas mixture is used (for example CF₄). The oxygen plasma dissociates the molecules into oxygen atoms which are very reactive. Creating reactive oxygen atoms enhances the oxidation of the substrate.

An example of a preferred cathodic sputtering method is the Metamode™ method from OCLI, combining all the above described characteristics, and the flow diagram of which is represented in FIG. 5.

Referring to FIG. 5, obtaining a metal oxide layer using the Metamode® method occurs in two distinct chambers, i.e. a cathodic sputtering chamber 1 where the metal from cathode 3 is sputtered onto the lens 4 placed on a tray 5 arranged on a rotating tray 6. Depositing the metal layer occurs as described hereinabove.

Once the metal layer is deposited, through rotating the tray 6, the lens 4 coated with a metal layer is conveyed to the oxidation chamber 2. In said chamber 2, an oxygen plasma is created (or an oxygen and a fluorinated gas, such as CF₄, plasma, if it is desired to obtain an oxyfluoride such as SiOₓF_{y}) for producing a metal oxide or silicon layer.

The metal/oxidation cathodic sputtering cycle is repeated as many times as needed for obtaining the desired thickness for the final metal oxide or SiO₂ final layer.

As an alternative, the metal cathodic sputtering/oxidation cycle can be repeated modifying the nature of the sputtered metal so as to thereby produce a stacking of metal oxide layers having different natures, for example, in order to produce an antireflection stacking.

The Metamode® method could be implemented with a sputtering device such as the Applied Vision RFX10 apparatus schematically illustrated, in a bottom view, in FIG. 6.

As shown in FIG. 6, the device comprises two cathodic sputtering chambers 1, 2, each provided with an inert gas supply, for example, argon, and a reaction chamber 3, (oxidation or oxyfluorination) provided with a gas supply (oxygen or a mixture of oxygen and a fluorinated gas such as CF₄). The chambers are connected with a vacuum system (not shown in FIG. 6). The substrates to be coated are placed on trays and are supplied to the rotating plate 4 of the device by means of a loading airlock 5. The device further comprises means for monitoring the vacuum 6, such as a Penning gauge, and monitoring and controlling means 7 for the cathodic sputtering and oxidation conditions.

The substrates to be coated, introduced through the loading airlock, are supplied by means of a rotating plate 4 in the cathodic sputtering chamber 1 or 2 where they are coated with a metal or silicon layer, as described hereinabove. After deposition of the metal or the silicon layer, the substrates are supplied into the reaction chamber 3 for carrying out the oxidation or the oxifluorination of the metal or the silicon layer.

At the end of the processing, the coated substrates are unloaded through the airlock 5.

### EXAMPLE 32

Silicon flat substrates are coated using the Metamode® method with:
1) a SiOF layer deposited by means of cathodic spraying (sputtering), and
2) a SiO₂ protective layer also deposited by cathodic sputtering.
   Deposition Condition for the SiOF+Barrier SiO₂ Layers

Introducing CF₄ occurs through the same gas line as oxygen.
Power on the magnetron with the silicon: 1.5 kW
Plasma gun power (oxygen plasma): 100 W
Deposition of the SiOF layer: (time 900 s; => thickness 165 nm)
   Ar flow rate (for Si sputtering): 12 sccm
   O₂ flow rate: 4 sccm
   CF₄ flow rate: 2 sccm
   P: 3 m Torr (0,4 Pa)
Deposition of the barrier layer: (time 90 s; => thickness 15 nm)
   Ar flow rate (for Si sputtering): 12 sccm
   O₂ flow rate: 4 sccm
   CF₄ flow rate: ---
   P: 2,6 m Torr (0.35 Pa)

Between both layers the deposition is preferably stopped for ˜30 seconds in order to ensure there is no more CF₄ left in the system.

Result: Refractive index of the SiOF layer=1.415 at 632.8 nm, stable over time.

1-21. (canceled)

22. A method for obtaining a stabilized SiOₓF_{y} fluorine-doped silica thin layer, comprising forming on a SiOₓF_{y} silicon oxyfluoride layer, a SiO₂ silica and/or a metal oxide protective layer through ion beam-assisted vapor phase deposition, comprising bombarding the layer being formed with a beam of positive ions formed from a rare gas, from oxygen or from a mixture of two or more of such gases, or through cathodic sputtering of a metal or silicon layer followed by an oxidation step of the deposited metal or silicon layer.

23. The method of claim 22, wherein the protective layer is 2 to 40 nm thick.

24. The method of claim 23, wherein the protective layer is 5 to 30 nm thick.

25. The method of claim 24, wherein the protective layer is 5 to 20 nm thick.

26. The method of claim 22, wherein the gas used for the ion beam assistance comprises argon, xenon, and/or oxygen.

27. The method of claim 26, wherein the gas comprises argon and xenon.

28. The method of claim 22, wherein the SiOₓF_{y} layer is 5 to 300 nm thick.

29. The method of claim 28, wherein the SiOₓF_{y} layer is 30 to 100 nm thick.

30. The method of claim 22, wherein the refractive index of the SiOₓF_{y} layer ranges from 1.38 to 1.44, for a wavelength of 630 nm and at 25° C.

31. The method of claim 22, wherein the SiOₓF_{y} layer is produced through silicon cathodic sputtering followed by an oxidation step in the presence of a fluorinated gas.

32. The method of claim 31, wherein the fluorinated gas is CF₄.

33. The method of claim 22, further defined as a method of producing an anti-reflection multi-layered coating formed on a substrate, comprising at least one stabilized thin layer coated with a silica and/or metal oxide protective layer.

34. The method of claim 33, wherein the anti-reflection coating is further defined as comprising a stacking of high index (HI) and low index (LI) layers, at least one of the low index layers being made of a thin layer coated with a silica and/or metal oxide protective layer.

35. The method of claim 34, wherein the anti-reflection coating is further defined as comprising a higher layer of the stacking that is the low index layer coated with a silica and/or metal oxide protective layer.

36. The method of claim 35, wherein the anti-reflection coating is further defined as comprising four layers in respective order HI/LI/HI/LI starting from the substrate surface.

37. The method of claim 36, wherein the anti-reflection coating is further defined as comprising thicknesses of the layers that vary, in respective order, starting from the substrate surface:
HI: from 10 to 40 nm;
LI: from 10 to 55 nm;
HI: from 30 to 155 nm;
LI (SiOₓF_{y} layer): from 70 to 110 nm; and
a protective layer: from 2 to 50 nm.

38. The method of claim 37, wherein the thickness of the LI layer closest to the substrate surface is 10 to 45 nm.

39. The method of claim 37, wherein the thickness of the HI layer closest to the SiOₓF_{y} layer is from 40 to 150 nm.

40. The method of claim 39, wherein the thickness of the HI layer is from 120 to 150 nm.

41. The method of claim 35, wherein the anti-reflection coating is further defined as comprising six layers in respective order HI/LI/HI/LI/HI/LI starting from the substrate surface.

42. The method of claim 41, wherein the anti-reflection coating is further defined as comprising thicknesses of the layers that vary, in respective order, starting from the substrate surface:
HI: from 10 to 30 nm;
LI: from 10 to 55 nm;
HI: from 10 to 160 nm;
LI: from 10 to 45 nm;
HI: from 35 to 170 nm;
LI: from 70 to 95 nm; and
a protective layer: from 2 to 40 nm.

43. The method of claim 42, wherein the thickness of the LI layer closest to the substrate surface is from 10 to 45 nm.

44. The method of claim 33, wherein the substrate is an organic glass.

45. The method of claim 44, wherein the organic glass comprises an anti-abrasion coating and/or an anti-shock coating.

46. The method of claim 22, further defined as a method of making an ophthalmic lens comprising organic glass and an anti-reflection coating comprising at least one stabilized thin layer coated with a silica and/or metal oxide protective layer.

47. A stabilized SiOₓF_{y} fluorine-doped silica thin layer coated with a silica and/or metal oxide protective layer.

48. The thin layer of claim 47, wherein the protective layer is 2 to 40 nm thick.

49. The thin layer of claim 48, wherein the protective layer is 5 to 30 nm thick.

50. The thin layer of claim 49, wherein the protective layer is 5 to 20 nm thick.

51. The thin layer of claim 47, wherein the SiOₓF_{y} layer is 5 to 300 nm thick.

52. The thin layer of claim 51, wherein the SiOₓF_{y} layer is 30 to 100 nm thick.

53. The thin layer of claim 47, wherein the refractive index of the SiOₓF_{y} layer ranges from 1.38 to 1.44 for a wavelength of 630 nm and at 25° C.

54. The thin layer of claim 47, further defined as comprised in an anti-reflection multi-layered coating formed on a substrate, the coating comprising at least one stabilized thin layer coated with a silica and/or metal oxide protective layer.

55. The thin layer of claim 54, wherein the anti-reflection coating is further defined as comprising a stacking of high index (HI) and low index (LI) layers, at least one of the low index layers being made of a thin layer coated with a silica and/or metal oxide protective layer.

56. The thin layer of claim 55, wherein the anti-reflection coating is further defined as comprising a higher layer of the stacking that is the low index layer coated with a silica and/or metal oxide protective layer.

57. The thin layer of claim 56, wherein the anti-reflection coating is further defined as comprising four layers in respective order HI/LI/HI/LI starting from the substrate surface.

58. The thin layer of claim 57, wherein the anti-reflection coating is further defined as comprising thicknesses of the layers that vary, in respective order, starting from the substrate surface:
HI: from 10 to 40 nm;
LI: from 10 to 55 nm;
HI: from 30 to 155 nm;
LI (SiOₓF_{y} layer): from 70 to 110 nm; and
a protective layer: from 2 to 50 nm.

59. The thin layer of claim 58, wherein the thickness of the LI layer closest to the substrate surface is 10 to 45 nm.

60. The thin layer of claim 58, wherein the thickness of the HI layer closest to the SiOₓF_{y} layer is from 40 to 150 nm.

61. The thin layer of claim 60, wherein the thickness of the HI layer is from 120 to 150 nm.

62. The thin layer of claim 56, wherein the anti-reflection coating is further defined as comprising six layers in respective order HI/LI/HI/LI/HI/LI starting from the substrate surface.

63. The thin layer of claim 62, wherein the anti-reflection coating is further defined as comprising thicknesses of the layers that vary, in respective order, starting from the substrate surface:
HI: from 10 to 30 nm;
LI: from 10 to 55 nm;
HI: from 10 to 160 nm;
LI: from 10 to 45 nm;
HI: from 35 to 170 nm;
LI: from 70 to 95 nm; and
a protective layer: from 2 to 40 nm.

64. The thin layer of claim 63, wherein the thickness of the LI layer closest to the substrate surface is from 10 to 45 nm.

65. The thin layer of claim 54, wherein the substrate is an organic glass.

66. The thin layer of claim 65, wherein the organic glass comprises an anti-abrasion coating and/or an anti-shock coating.

67. The thin layer of claim 47, further defined as comprised in an ophthalmic lens.
